(19) United States
(12) Patent Application Publication
(10) Pub. No.: US 2003/0066089 A1
(43) Pub. Date: Apr. 3, 2003

(54) Trigger mechanism for sync-to-broadcast web content

(76) Inventor: David Andersen, Hillsboro, OR (US)

Correspondence Address: BLAKELY, SOKOLOFF, TAYLOR & ZAFMAN LLP, Seventh Floor, 12400 Wilshire Boulevard, Los Angeles, CA, 90025-1026, US

(21) Appl. No.: 09/966,279

(22) Filed: Sep. 28, 2001

(51) Int. Cl. H04N 7/173; H04N 7/16; H04N 7/00; H04N 11/00

(52) U.S. Cl. 725/112; 348/460; 348/465; 725/136; 348/462

(57) ABSTRACT

A system, apparatus, and method are provided for device interaction using a trigger mechanism. According to one embodiment of the present invention, a trigger, such as an audio tone sequence, may be inserted in the feed of a program to cause the web device to retrieve appropriate web content.

### COPYRIGHT NOTICE

Contained herein is material that is subject to copyright protection. The copyright owner has no objection to the facsimile reproduction of the patent disclosure by any person, as it appears in the Patent and Trademark Office patent files or records, but otherwise reserves all rights to the copyright whatsoever.

### FIELD OF THE INVENTION

This invention relates to the field of device interaction, in general, and more specifically to providing a trigger mechanism for experiencing content on a multimedia device and, automatically, experiencing related web content on a web device.

### BACKGROUND OF THE INVENTION

The idea of combining entertainment programming with related web content is nothing new. For example, many attempts have been made to allow the users to access the Internet while watching television programming to experience same or related content on the Internet. Typically, Uniform Resource Locators (URLs) are listed on the television screen, and the users are expected to type in the URLs on their web devices. For example, the Public Broadcasting Station (PBS) is known for listing their website address (www.pbs.org) at the bottom of the television screen every time related and/or additional information regarding the topic of the show, such as Frontline, is available on their website.

In some cases, the users are required to download and install a program-specific application on their web device, and then run the application simultaneously with the television program. For example, ABC's Enhanced TV allows users to log into ABC's Enhanced TV website to experience content on two screens, simultaneously, such as playing Who Wants to be a Millionaire using a web device, while watching the show on television. ABC's Enhanced TV, however, requires a user to log into ABC's website, and is primarily designed for the user to interact by playing the game.

Some companies, such as ATI Technologies, are now offering TV tuner cards (cards). Users can install the cards into their computers to experience telewebbing. However, the purpose of such cards is to have computers replace conventional televisions. The cards are not designed to have a computer operate side-by-side with a television allowing a user to watch a television program and receive related web content on the computer.

The methods and apparatus available today require the users to log into the websites listed on their television screens, replace televisions with computers or vice versa, or require additional hardware to connect computers and/or web devices with televisions.

### BRIEF DESCRIPTION OF THE DRAWINGS

The appended claims set forth the features of the invention with particularity. The invention, together with its advantages, may be best understood from the following detailed description taken in conjunction with the accompanying drawings of which:

FIG. 1 is a block diagram conceptually illustrating device interaction using a triggering mechanism, according to one embodiment of the present invention;

FIG. 2 is a block diagram of an exemplary web device upon which one embodiment of the present invention may be implemented;

FIG. 3 is a flow diagram conceptually illustrating a process of device interaction using a triggering mechanism, according to one embodiment of the present invention;

FIG. 4 is a block diagram illustrating trigger analysis, according to one embodiment of the present invention; and

FIG. 5 is a flow diagram illustrating a process of trigger analysis, according to one embodiment of the present invention.

### DETAILED DESCRIPTION

A method and apparatus are described for automatically synchronizing web content displayed by a web device with a broadcast program. Broadly stated, embodiments of the present invention allow a user to experience content on a multimedia device and related web content on a web device, simultaneously and automatically by using audio input embedded within the content as a trigger mechanism for the web device.

A system, apparatus, and method are provided for device interaction using a trigger mechanism. According to one embodiment of the present invention, a trigger, such as an audio tone sequence, may be inserted in the feed of a program to cause the web device to retrieve appropriate web content.

According to one embodiment, the triggering mechanism may be wireless, for example, having an audio trigger using a tone sequence embedded in the audio feed of a program. The web device may constantly listen for such tone sequence by various means, such as using a zero crossing detection algorithm, to recognize the tone sequences and their respective durations. The tone sequence may then be translated into a numeric code.

According to another embodiment, an audio trigger may be generic in nature, and therefore, may not depend on only one type of trigger provided by any one type of broadcaster or multimedia device. Similarly, a user may use various combinations of types of multimedia device, web device, application, and/or operating system.

In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

The present invention includes various steps, which will be described below. The steps of the present invention may be performed by hardware components or may be embodied in machine-executable instructions, which may be used to cause a general-purpose or special-purpose processor or logic circuits programmed with the instructions to perform the steps. Alternatively, the steps may be performed by a combination of hardware and software.

The present invention may be provided as a computer program product, which may include a machine-readable medium having stored thereon instructions, which may be used to program a computer (or other electronic devices) to perform a process according to the present invention. The machine-readable medium may include, but is not limited to, floppy diskettes, optical disks, CD-ROMs, and magneto-optical disks, ROMs, RAMs, EPROMs, EEPROMs, magnetic or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem or network connection).

Importantly, while embodiments of the present invention will be described with reference to viewers and streaming video, the apparatus and methods described herein are equally applicable to various other types of media and multimedia. For example, viewers and/or listeners may receive steaming audio and video, streaming audio, text, graphics, animation, data, and the like.

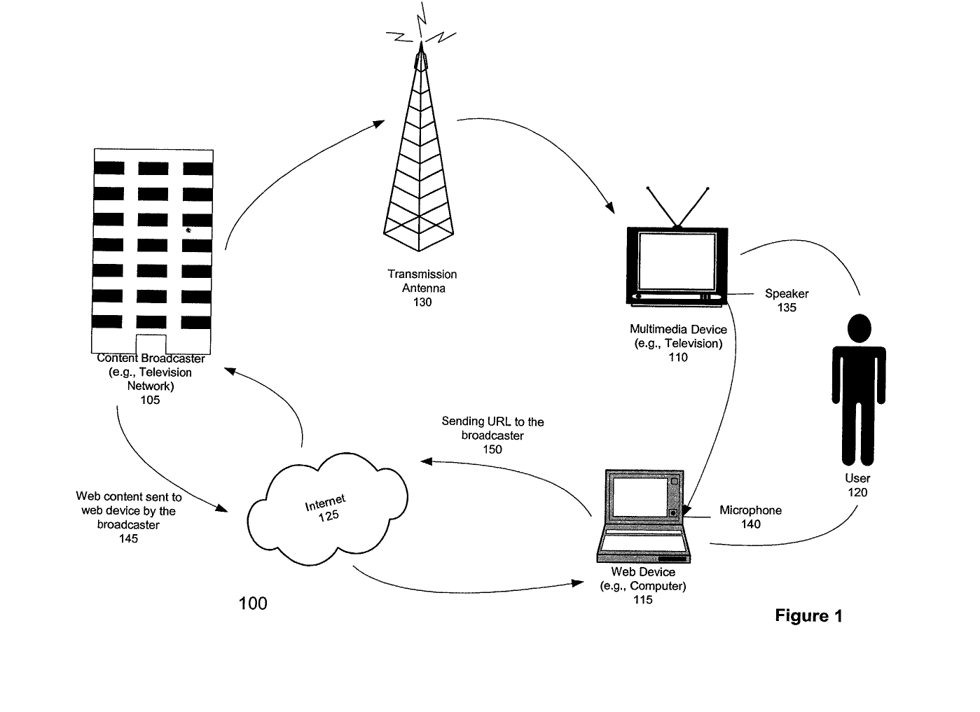

FIG. 1 is a block diagram conceptually illustrating device interaction using a triggering mechanism, according to one embodiment of the present invention. By way of example, and as illustrated, according to one embodiment, a content distribution network 100 comprises a content broadcaster (broadcaster) 105, a multimedia device 110, such as a television, and a web device 115, such as a personal computer (computer or PC), web tablet, personal digital assistant (PDA), or laptop. The components of the content distribution network 100, such as content broadcaster 105, multimedia device 110, and the web device 115, and the user 120 are all linked together via network links. It is noted that the discussion regarding the network 100 and its various components is for the purposes of illustration, and that the embodiments of the present invention are not limited to it.

According to one embodiment, the broadcaster 105 may comprise a television network, such as NBC, ABC, CBS, or PBS, a cable provider, such as HBO, Showtime, or CNN, a local content provider, such as KABC or KNBC, a cable operator/provider, such as AT&T or Comcast Cable, or a satellite service provider, such as DirectTV or Echostar. Broadcasters 105 may include any content generator, transmitters and/or recorders, including music recording agencies and movie studios, such as Capitol Records and Universal Studios.

According to one embodiment, a trigger may include any type of analog or digital signal used to cause a web device to retrieve web content. The trigger may also include an audio or video signal, or any other type of signal contemplated by one with ordinary skill in the art. In the examples discussed herein the trigger is typically an audio tone sequence embedded into an audio signal by the broadcasters, as defined above.

According to one embodiment, in addition to or instead of broadcasters inserting triggers into programming, advertisers may insert triggers into their commercials. This could be performed either by the advertisers or by the broadcasters 105 upon a request by the advertisers. However, commercials containing triggers inserted by the advertisers may be independent of the broadcasters 105. In essence, an advertiser, e.g., Coca-Cola may have a second channel, appearing on the second display screen of the web device 115, through which the advertiser may communicate interactively with its consumers and potential consumers.

According to one embodiment, the content receiving and trigger emitting device could be any type of multimedia device 110. As illustrated, for example, the broadcaster 105, or a combination of broadcasters, broadcast a program, in which one or more triggers are embedded, via transmission antenna 130 to the user's television 110. The multimedia device 110 may not have the content display capabilities, for example, it could be a radio, receiving music or talk programs from a radio station. Further, the multimedia device 110 may not necessarily be a receiving device capable of receiving live transmission of content. The multimedia device 110 may comprise a device for playing recorded content as opposed to receiving and providing live content. For example, a television may send a trigger embedded in a tape-recorded movie being played using a video cassette recorder (VCR), or a compact disk (CD) player may send an audio trigger embedded in a pre-recorded music CD, just as a radio or television may receive and emit an audio trigger while playing recorded music or even a live concert. Similarly, the multimedia device 110 may include cassette players, DVD players, computers, and all other multimedia devices known or contemplated by one of ordinary skill in the art.

By way of example and as illustrated, according to one embodiment, the broadcaster 105 may transmit a program to a user's television 110 via a transmission antenna 130. The broadcaster 105 may have already created a website populated with web content relating to the program via the Internet 125. The broadcaster 105 may also have created one or more triggers, such as audio tone sequences, and associated the triggers with related web content. The broadcaster 105 may then embed the triggers into the program being transmitted to the television 110. As the user 120 watches the program, at a pre-determined time, which may have been determined by the broadcaster 105, a trigger is delivered via the television speaker 135.

According to one embodiment, an audio input device of the computer, such as a microphone 140, may sense the trigger. In response, the computer 115 may retrieve and display the corresponding web page including the related web content for the user 120. The web page maybe displayed automatically, without user intervention, and the user 120 may simultaneously view the web page while watching the program, in Attorney progress, on television 110. The web page may remain open on the computer screen for a predetermined time period.

According to one embodiment, the predetermined time period may be based on the user's 120 or the broadcaster's 105 criteria, factors and/or terms, or may be based on a combination of such. For example, the user 120 may set the time period as: keep the web page open until the computer 115 receives the next trigger. In such a case, as soon as the next trigger is received by the computer 115, the current web page may close, and a new web page may open. If the new web page is the same as the current web page, the current web page may simply be refreshed. As another example, the user 120 may also set a time period, independent of the next trigger and/or web page, such as allow unconditional fifteen (15) minutes to keep a web page open. In such as case, if another trigger sounds before the 15-minute time period is over, the computer 115 may display multiple windows displaying multiple web pages, or simply store the next web page and wait for the time period to expire. Furthermore, the user 120 may also choose to access the web page at a later time, even after the program has ended, as defined by the predetermined criteria.

According to one embodiment, the volume level of the trigger may range from very low to very high decibel level corresponding to the volume level chosen by the user 120. The user may choose to adjust the volume level, and consequently, adjust the trigger's decibel level. Further, the user 120 may choose to connect the television 110 with the computer 115 to completely avoid listening to the trigger. The trigger 120 may be set to an extremely low decibel level-enough for the web device to sense, but negligibly low level for the human ear. Various levels of decibel levels may be used as required by the system, network, apparatus, and user needs, as contemplated by one of ordinary skill in the art.

Although, FIG. 1 illustrates a computer 115 as an example of a web device, the web device 115 may include various other types of devices, such as web terminals, kiosks, and touch screens. Further, the web device 115 is not be limited to a particular operating system or web application.

According to one embodiment, conventional technologies may be used, together with any desirable modifications that will be apparent to those skilled in the art. For example, the content distribution network 100 may comprise a conventional processor to execute instructions, a conventional memory to store content, a conventional encoder to encode content, a conventional transmitter to transmit a content containing signal, a conventional receiver to receive the content containing signal, and a conventional decoder to decode content, including the trigger. Without limitation, the content may be converted to an MPEG format, transmitted via a tower antenna over an atmospheric communication medium, received by an antenna, and converted from the MPEG format to an uncompressed useable format.

According to one embodiment, the content distribution network 100 may comprise a content transmission system to transmit the content and a content reception system to receive the content. The term “transmission” or “delivery” and related terms will be used broadly to refer to moving data, frequently digital data, from one place or system to another and the term “reception” or “receiving” and related terms will be used broadly to refer to accepting the moved data. Typically, transmission will include generating and submitting a content-containing machine-accessible signal, and receiving will include accepting and interpreting the content-containing machine-accessible signal. For example, the transmission tower 130 may broadcast an electromagnetic radiation content-containing signal simultaneously to multiple receiving antennas (e.g., rabbit ear antennas) operable to accept the signal. Alternatively, rather than broadcasting, the signal may be narrowcast to specific recipients, similarly to the way cable television is delivered to cable subscribers.

According to one embodiment, the content transmission system may transmit the content over a substantially one-way communication link, in which the predominant or only transmission is from the content transmission system to a content reception system. According to one embodiment, the link may be bi-directional, although typically, the link will be a substantially non-client-server link. A client-server link would be typified by the content reception system issuing a request for the content and the content transmission system then issuing the content in response, similarly to the way that a web page may be received using the Internet 125. In contrast, in a non-client-server link, the content transmission system may provide the content without the request. That is, the content transmission system may transmit content to the content reception system, and typically a plurality of other content reception systems simultaneously, without receiving a specific request that is processed and responded to or supplied.

According to one embodiment, various components of the content distribution network 100 may be a linked via a network link. The network link may be based on a number of technologies, including satellite, dish, fiber optic, coaxial cable, and others. For example, the link may be a one way broadcast pipe in which the content is simultaneously broadcast to various multimedia devices 110 of the content distribution network 100 linked via an antenna like rabbit ears or a satellite dish to receive the content, or narrowcast to a select group of multimedia devices 110 of the content distribution network 100 having authorization to receive the content.

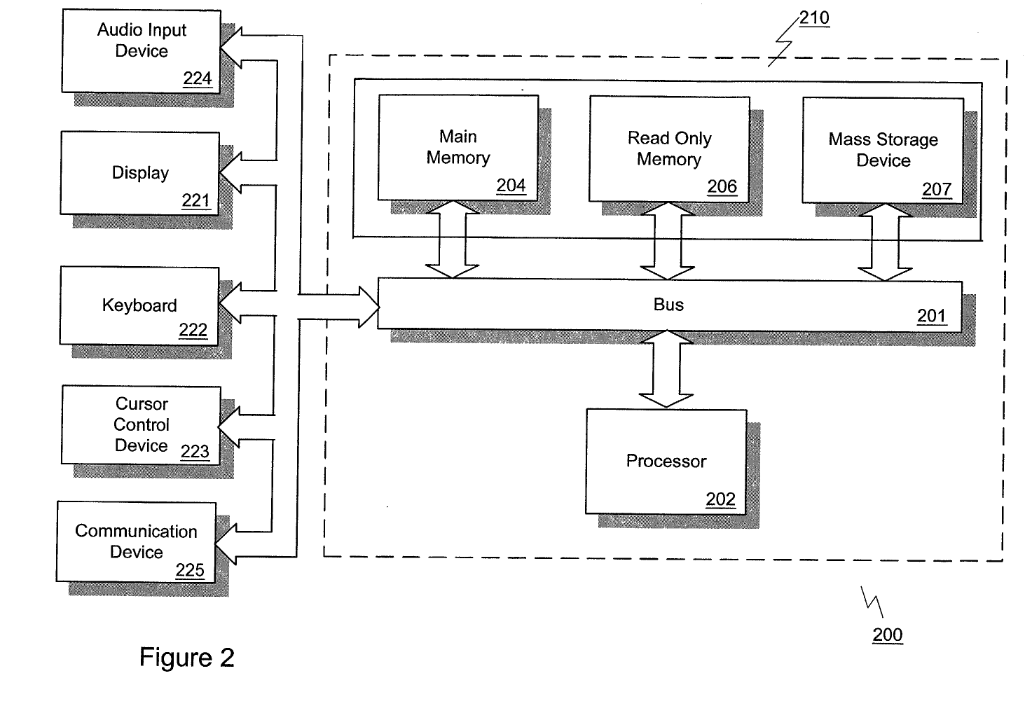

FIG. 2 is a block diagram of an exemplary web device upon which one embodiment of the present invention may be implemented. Computer system 200 comprises a bus or other communication means 201 for communicating information, and a processing means such as processor 202 coupled with bus 201 for processing information. Computer system 200 further comprises a random access memory (RAM) or other dynamic storage device 204 (referred to as main memory), coupled to bus 201 for storing information and instructions to be executed by processor 202. Main memory 204 also may be used for storing temporary variables or other intermediate information during execution of instructions by processor 202. Computer system 200 also comprises a read only memory (ROM) and/or other static storage device 206 coupled to bus 201 for storing static information and instructions for processor 202.

A data storage device 207 such as a magnetic disk or optical disc and its corresponding drive may also be coupled to computer system 200 for storing information and instructions. Computer system 200 can also be coupled via bus 201 to a display device 221, such as a cathode ray tube (CRT) or Liquid Crystal Display (LCD), for displaying information to an end user. Typically, an alphanumeric input device 222, including alphanumeric and other keys, may be coupled to bus 201 for communicating information and/or command selections to processor 202. Another type of user input device is cursor control 223, such as a mouse, a trackball, or cursor direction keys for communicating direction information and/or command selections to processor 202 and for controlling cursor movement on display 221. An audio input device 224 may also be coupled to the bus 201 for communicating audio information and/or command selections to processor 202.

A communication device 225 is also coupled to bus 201. The communication device 225 may include a modem, a network interface card, or other well-known interface devices, such as those used for coupling to Ethernet, token ring, or other types of physical attachment for purposes of providing a communication link to support a local or wide area network, for example. In this manner, the computer system 200 may be coupled to a number of clients and/or servers via a conventional network infrastructure, such as a company's Intranet and/or the Internet, for example.

It is appreciated that a lesser or more equipped computer system than the example described above may be desirable for certain implementations. Therefore, the configuration of computer system 200 will vary from implementation to implementation depending upon numerous factors, such as price constraints, performance requirements, technological improvements, and/or other circumstances.

It should be noted that, while the steps described herein may be performed under the control of a programmed processor, such as processor 202, in alternative embodiments, the steps may be fully or partially implemented by any programmable or hard-coded logic, such as Field Programmable Gate Arrays (FPGAs), TTL logic, or Application Specific Integrated Circuits (ASICs), for example. Additionally, the method of the present invention may be performed by any combination of programmed general-purpose computer components and/or custom hardware components. Therefore, nothing disclosed herein should be construed as limiting the present invention to a particular embodiment wherein the recited steps are performed by a specific combination of hardware components.

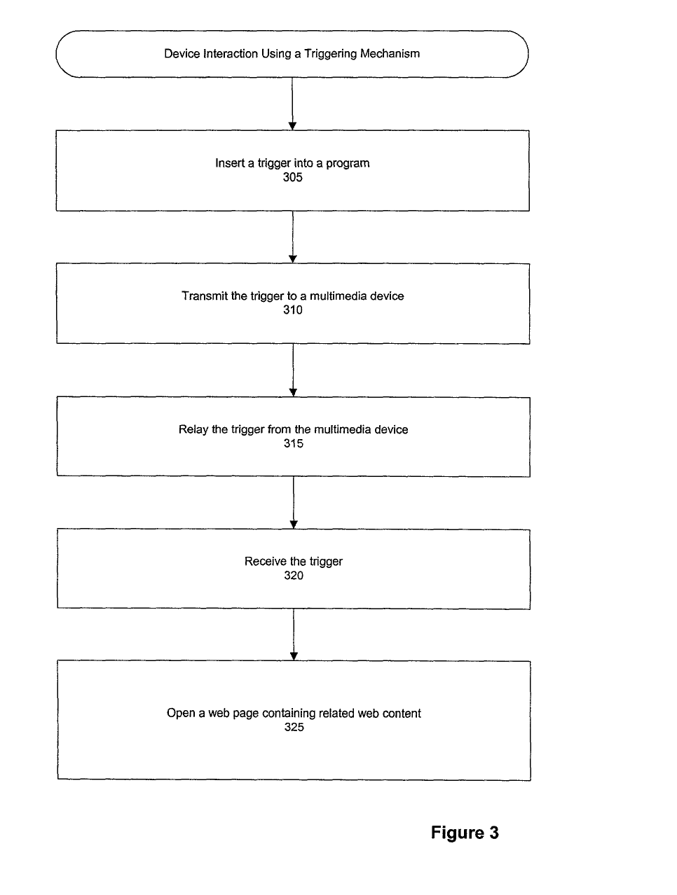

FIG. 3 is a flow diagram conceptually illustrating a process of device interaction using a triggering mechanism, according to one embodiment of the present invention. First, a trigger, such as, but not limited to, an audio trigger is embedded at an appropriate point into a program by a program broadcaster in processing block 305. The audio trigger may comprise a tone sequence. The program is broadcast by the broadcaster, and presented on a multimedia device, such as, but not limited to, a television. The trigger is transmitted to the multimedia device via the program in processing block 310. The audio trigger is emitted from the multimedia device when the predetermined point is reached in the program in processing block 315. A web device, such as, but not limited to, a computer with Internet access, receives the trigger by sensing the audio trigger in processing block 320. After analyzing the audio trigger, the web device accesses the related web content, and opens the web page containing the web content in processing block 325. Advantageously, in this manner telewebbing is made easier for the user by making it possible for broadcast-associated webpages to be automatically displayed at the proper time without requiring user action.

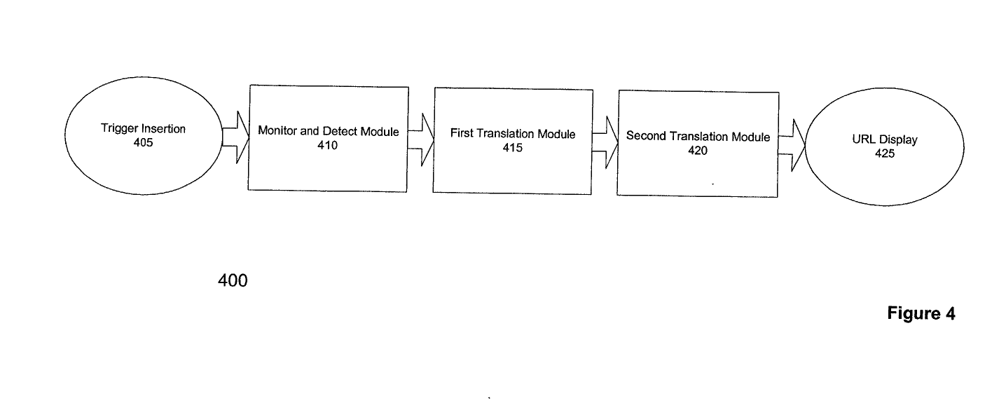

FIG. 4 is a block diagram illustrating trigger analysis, according to one embodiment of the present invention. A broadcaster, as defined with relation to FIG. 3, may insert a trigger 405 into the portion of a program. For example, a network, such as the National Broadcasting Corporation (NBC) may insert a multi-tone triggering sequence 405 into the audio portion of its program. Multiple tones, multiple sequences, or multiple triggers may be used to serve multiple purposes. For example, NBC may choose to insert multiple audio triggers 405 into its NBA on NBC program, where each of the multiple audio triggers may correspond to a related website. Such multiple audio triggers may include triggers to identify NBC and the local broadcasters, provide information regarding NBC and the NBA, and lead users to individual team websites. Similarly, a broadcaster, e.g., NBC, or an advertiser, Coca-Cola, may include triggers 405 into the advertiser's commercials/advertisements corresponding to related websites, e.g., http://www.coca-cola.com.

According to one embodiment, a trigger may comprise a set of components based on a predetermined criteria. For example, a component from the set of components may serve as a unique identifier for uniquely identifying the broadcaster, e.g., NBC. The trigger may also comprise a set of specific parameters, e.g., audio parameters, to allow the web device to recognize a given trigger by matching the parameters with the parameters made known to the web device. Such parameters may include a list of tone sequences, the duration of such tone sequences, and/or the frequency and amplitude measurements corresponding to a frequency domain analysis. The parameters may also include parameters for specific digital filters for detecting the trigger.

According to one embodiment, a monitor and detection module 410 may constantly monitor the content of the programs for triggers. The monitoring and detection of the programs may be performed constantly as a background task, periodically, or whenever necessary. The monitor and detection module 410 may employ specific parameters to monitor and detect the triggers embedded in the content of the program. For example, the monitor and detection module 410 may monitor the incoming audio waveforms of the program to detect an audio trigger by matching the frequency parameters to the corresponding frequency parameters in the audio waveform of the program. In other words, the monitor and detection module 410 may detect a trigger based on the predetermined parameters and criteria as defined by the broadcasters, multimedia and web device manufactures, system managers, or users, or by any combination of such. According to one embodiment, a zero crossing detection algorithm may be employed to detect and recognize the sequence tones, and their respective durations. The detection algorithm may be written in a portable language, such as, but not limited to, JAVA. Once the trigger is detected, information representing the trigger is sent to a first translation module 415 for further analysis.

According to one embodiment, the first translation module 415 may translate the information received from the monitor and detection module 410 into a numeric code. The numeric code may numerically represent the same components that were initially inserted into the trigger by the broadcaster. Once the information is translated into the numeric code, the numeric code may then be forwarded to a second translation module 420 for further analysis.

According to one embodiment, the second translation module 420 may employ a static translation table to map the information received from the first translation module 415 with the corresponding websites containing the related web content. The second translation module 420 may translate the information received from the first translation module 415 to the corresponding URL. The web device may then retrieve and display a website 425 corresponding to the URL as determined by the second translation module. For example, the trigger embedded in the program (e.g., NBA on NBC), may correspond to the team website of the Los Angeles Lakers. Consequently, the web device would display the Lakers' team website at http://www.lakers.com.

According to one embodiment, the system 400 may be scaleable so that not every user accesses the same website at the same time. Scalability of the system 400 may be achieved in various ways, for example, a trigger may be zip code-diversed, wherein the zip code-diversed trigger may know where and when a certain tone sequence is to be relayed, and therefore adjust the triggering mechanism accordingly. For example, a trigger in zip code 90210 (Beverly Hills, Calif.) may be delayed by a certain time-period relative to a trigger in zip code 80210 (Denver, Colo.). The time-period may range from few seconds to several days depending on circumstances, application, and/or predetermined criteria. In alternative embodiments, users in different zip codes may be sent to different websites or receive different triggers.

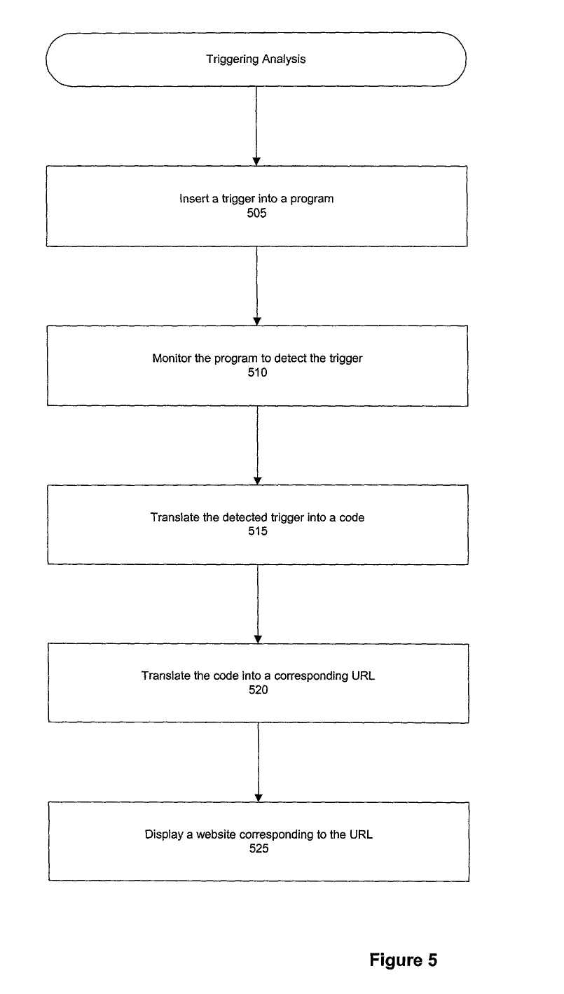

FIG. 5 is a flow diagram illustrating a process of trigger analysis, according to one embodiment of the present invention. First, a trigger, comprising a predetermined criteria, is inserted into a program by a broadcaster in processing block 505. The waveforms are monitored for detecting a possible trigger in processing block 510. The detected trigger is then translated into a numeric code in processing block 515. The numeric code is then translated into a corresponding URL in processing block 520 using a translation table downloaded in advance from the broadcaster's website, for example. According to another embodiment, the trigger itself may represent the URL. The web device then retrieves and displays the website, containing the related web content, corresponding to the URL in processing block 525.

What is claimed is:

1. A method comprising:
inserting a trigger into a program, wherein the trigger comprises a predetermined criteria;
broadcasting the program comprising the trigger;
transmitting the trigger based on the predetermined criteria;
detecting the trigger based on the predetermined criteria; and
displaying a website corresponding to the trigger.

2. The method of claim 1, wherein the inserting the trigger into a program comprises inserting the trigger into the content of the program.

3. The method of claim 1, wherein the trigger comprises an audio trigger, wherein the audio trigger comprises audio tone sequences.

4. The method of claim 1, wherein the trigger comprises a video trigger, wherein the video trigger comprises the audio tone sequences and video motion sequences.

5. A method comprising:
providing web content relating to a broadcast program;
providing a trigger event for a web device in the form of an audio tone sequence associated with the web content; and
causing the web device, located sufficiently close to a receiving device to detect the audio tone sequence when emitted by the receiving device, to retrieve and present the web content concurrent with the presentation of the broadcast program by the receiving device by embedding the audio tone sequence into an audio feed of the broadcast program.

6. The method of claim 5, wherein the web device comprises a web tablet.

7. The method of claim 5, wherein the web device comprises a computer system.

8. The method of claim 5, wherein the receiving device comprises a television.

9. A method comprising:
monitoring audio output of a receiving device, that is receiving and presenting a broadcast program, for a trigger in the form of an audio tone sequence;
in response to detecting the trigger, determining a uniform resource locator (URL) of web content associated with the broadcast program based on the audio tone sequence; and
synchronizing the web content to the broadcast program without the need for user action by automatically retrieving and presenting the web content simultaneous with the presentation of the broadcast program.

10. The method of claim 9, wherein the presenting the web content comprises diversified presentation of the web content based on a predetermined criteria comprising time-based diversification and location-based diversification.

11. The method of claim 9, further comprising terminating the presentation of the web content based on the predetermined criteria.

12. A device interaction system comprising:
a broadcaster to embed a trigger into a program;
a multimedia device to transmit the trigger; and
a web device to display a website corresponding to the trigger.

13. The device interaction system of claim 12, wherein the broadcaster is further to broadcast the program along with the embedded trigger to the multimedia device.

14. The device interaction system of claim 12, wherein the broadcaster comprises the following: a television network, a radio network, a cable provider/operator, a local broadcaster, a satellite system provider, and a content recorder.

15. The device interaction system of claim 12, wherein the multimedia device is further to receive the program embedded with the trigger from the broadcaster.

16. The device interaction system of claim 12, wherein the multimedia device comprises the following: a television, a radio, a computer, a CD player, a cassette player, and a DVD player.

17. The device interaction system of claim 12, wherein the web device is further to detect the trigger transmitted by the multimedia device.

18. A method of trigger analysis comprising:
inserting a trigger into a program, wherein the trigger comprises parameters;
monitoring the program to detect the trigger;
detecting the trigger;
translating the trigger into a corresponding URL;
displaying a website corresponding to the URL.

19. The method of claim 18, further comprising broadcasting the program containing the inserted trigger.

20. The method of claim 18, wherein the monitoring the program to detect the trigger comprises recognizing the parameters of the trigger.

21. The method of claim 18, wherein the detecting the trigger comprises matching the recognized parameters of the trigger to predetermined parameters.

22. The method of claim 18, wherein the translating the trigger into a corresponding URL comprising:
translating the trigger into a code;
translating the code into the corresponding URL.

23. A machine-readable medium having stored thereon data representing sequences of instructions, the sequences of instructions which, when executed by a processor, cause the processor to:
insert a trigger into a program, wherein the trigger comprises a predetermined criteria;
broadcast the program comprising the trigger;
transmit the trigger based on the predetermined criteria;
detect the trigger based on the predetermined criteria; and
display a website corresponding to the trigger.

24. The machine-readable medium of claim 23, wherein the trigger comprises an audio trigger, wherein the audio trigger comprises audio tone sequences.

25. The machine-readable medium of claim 23, wherein the trigger comprises a video trigger, wherein the video trigger comprises the audio tone sequences and video motion sequences.

26. A machine-readable medium having stored thereon data representing sequences of instructions, the sequences of instructions which, when executed by a processor, cause the processor to:
insert a trigger into a program, wherein the trigger comprises parameters;
monitor the program to detect the trigger;
detect the trigger;
translate the trigger into a corresponding URL;
display a website corresponding to the URL.

27. The machine-readable medium of claim 26, wherein the sequences of instructions, which when executed by the processor, further causes the processor to broadcast the program containing the inserted trigger.

28. The machine-readable medium of claim 26, wherein the monitoring the program to detect the trigger further causes the processor to recognize the parameters of the trigger.

29. The machine-readable medium of claim 26, wherein the detecting the trigger further causes the processor to match the recognized parameters of the trigger to predetermined parameters.

30. The machine-readable medium of claim 26, wherein the translating the trigger into a corresponding URL further causes the processor to:
translate the trigger into a code;
translate the code into the corresponding URL.
